(19) United States
(12) Patent Application Publication
(10) Pub. No.: US 2019/0227710 A1
(43) Pub. Date: Jul. 25, 2019

(54) INCREMENTAL DATA RESTORATION METHOD AND APPARATUS

(71) Applicant: HUAWEI TECHNOLOGIES CO., LTD., Shenzhen (CN)

(72) Inventor: Guodong LI, Shenzhen (CN)

(21) Appl. No.: 16/371,526

(22) Filed: Apr. 1, 2019

Related U.S. Application Data
(63) Continuation of application No. PCT/CN2017/097678, filed on Aug. 16, 2017.

(30) Foreign Application Priority Data
Dec. 15, 2016 (CN) 201611161748.5

(51) Int. Cl. G06F 3/06

(52) U.S. Cl. CPC G06F 3/065; G06F 3/0683; G06F 3/0604

(57) ABSTRACT

An incremental data restoration method and apparatus are disclosed, and the method includes creating a current snapshot of data, determining a changed data block in the current snapshot relative to an m^{th} backup, where m is a positive integer, and the m^{th} backup is not a last backup, and restoring data corresponding to the changed data block to data corresponding to a corresponding data block in the m^{th} backup.

### CROSS-REFERENCE TO RELATED APPLICATIONS

This application is a continuation of International Application No. PCT/CN2017/097678, filed on Aug. 16, 2017, which claims priority to Chinese Patent Application No. 201611161748.5 filed on Dec. 15, 2016. The disclosures of the aforementioned applications are hereby incorporated by reference in their entireties.

### TECHNICAL FIELD

Embodiments of this application relate to data storage technologies, and in particular, to an incremental data restoration method and apparatus.

### BACKGROUND

In an information-based era, a large amount of data needs to be stored in a computer. To ensure that data is not lost due to a disaster, backup of the data is usually required. After the data is damaged, the data can be restored based on backup data.

Data restoration includes full restoration and incremental restoration. The full restoration is to restore all data, and the incremental restoration is to restore only a modified part between a current snapshot and a snapshot of a backup restoration point based on an existing disk. Because only data of the changed part is restored in the incremental restoration, and this part of data is usually far less than all data, a data restoration amount can be greatly reduced, and a restoration process is sped up. In the prior art, when data is restored through incremental restoration, a difference between a current snapshot and a snapshot of a backup restoration point is first analyzed, and a determined modified part is restored by using data at the restoration point.

However, in the prior art, because incremental data restoration can be performed only after a difference between a current snapshot and a snapshot of a backup restore point is analyzed, how to perform incremental data restoration when there is no snapshot of the backup restoration point becomes a technical problem that needs to be resolved.

### SUMMARY

Embodiments of this application provide an incremental data restoration method and apparatus, to resolve a prior-art technical problem of how to perform incremental data restoration when there is no snapshot of a backup restoration point.

According to a first aspect, an embodiment of this application provides an incremental data restoration method, including:

creating a current snapshot of data;

determining a changed data block in the current snapshot relative to an m^{th} backup, where m is a positive integer, and the m^{th} backup is not a last backup; and

restoring data corresponding to the changed data block to data corresponding to a corresponding data block in the m^{th} backup.

According to the incremental data restoration method provided in the first aspect, the current snapshot of the data is created, the changed data block in the current snapshot relative to the m^{th} backup is determined, and the data corresponding to the changed data block is restored to the data corresponding to the corresponding data block in the m^{th} backup. When the m^{th} backup is not a last backup, in other words, there is no snapshot of the m^{th} backup, the changed data block in the current snapshot relative to the m^{th} backup is determined, and the data corresponding to the changed data block is restored to the data corresponding to the corresponding data block in the m^{th} backup, so that incremental restoration is effective, and incremental restoration reliability can be improved.

In one embodiment, the determining a changed data block in the current snapshot relative to an m^{th} backup includes:

determining whether there is a changed data block between the current snapshot and a snapshot of a t^{th} backup, where t is a positive integer, and m is less than t; and determining a changed data block in the t^{th} backup relative to the m^{th} backup if there is no changed data block between the current snapshot and the snapshot of the t^{th} backup. The snapshot of the t^{th} backup is a snapshot of a last backup, and there is a snapshot of only the t^{th} backup.

In one embodiment, the restoring data corresponding to the changed data block to data corresponding to a corresponding data block in the m^{th} backup includes:

restoring data corresponding to the changed data block in the t^{th} backup relative to the m^{th} backup to data corresponding to a corresponding data block in the m^{th} backup.

In one embodiment, the snapshot of the t^{th} backup is a snapshot of a last backup. In addition, there is a snapshot of only the t^{th} backup, and there are no snapshots of other (t−1) backups. A system stores only the current snapshot and the snapshot of the t^{th} backup, and does not need to store snapshots of all backups. Therefore, storage space can be saved, and system performance can be improved.

When there is no changed data block between the current snapshot and the snapshot of the t^{th} backup, the data corresponding to the changed data block in the t^{th} backup relative to the m^{th} backup may be directly restored to the data corresponding to the corresponding data block in the m^{th} backup. Therefore, data restoration efficiency can be improved.

In one embodiment, the method further includes:

if there is a changed data block between the current snapshot and the snapshot of the t^{th} backup, the restoring data corresponding to the changed data block to data corresponding to a corresponding data block in the m^{th} backup includes:

restoring data corresponding to a changed data block in the current snapshot relative to the snapshot of the t^{th} backup to data corresponding to a corresponding data block in the t^{th} backup;

determining a changed data block in the t^{th} backup relative to the m^{th} backup; and

restoring data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the data corresponding to the changed data block in the current snapshot relative to the snapshot of the t^{th} backup may be first restored to the data corresponding to the corresponding data block in the t^{th} backup, and then the data corresponding to the changed data block in the t^{th} backup relative to the m^{th} backup is restored to the data corresponding to the corresponding data block in the m^{th} backup. When the m^{th} backup is not a last backup, in other words, there is no snapshot of the m^{th} backup, the changed data block in the current snapshot relative to the m^{th} backup is determined, and the data corresponding to the changed data block is restored to the data corresponding to the corresponding data block in the m^{th} backup, so that incremental restoration is effective, and incremental restoration reliability can be improved.

In one embodiment, the method further includes:

if there is a changed data block between the current snapshot and the snapshot of the t^{th} backup, the restoring data corresponding to the changed data block to data corresponding to a corresponding data block in the m^{th} backup includes:

recording a first storage location of a changed data block in the current snapshot relative to the snapshot of the t^{th} backup;

determining a changed data block in the t^{th} backup relative to the m^{th} backup, and recording a second storage location of the changed data block in the t^{th} backup relative to the m^{th} backup;

restoring data in the data block corresponding to the recorded first storage location to data corresponding to a corresponding data block in the t^{th} backup; and

restoring data in the data block corresponding to the recorded second storage location to data corresponding to a corresponding data block in the m^{th} backup.

In one embodiment, if there is a changed data block between the current snapshot and the snapshot of the t^{th} backup, the first storage location of the changed data block in the current snapshot relative to the snapshot of the t^{th} backup may be recorded; the changed data block in the t^{th} backup relative to the m^{th} backup is determined, and the second storage location of the changed data block in the t^{th} backup relative to the m^{th} backup is recorded; the data in the data block corresponding to the recorded first storage location is restored to the data corresponding to the corresponding data block in the t^{th} backup; and the data in the data block corresponding to the recorded second storage location is restored to the data corresponding to the corresponding data block in the m^{th} backup. Data restoration efficiency can be improved because all changed data blocks are restored together after all the changed data blocks are determined.

In one embodiment, before the determining a changed data block in the t^{th} backup relative to the m^{th} backup, the method further includes:

creating a backup mapping table, where the backup mapping table includes a storage location of the data block and a change identifier of the data block, the change identifier is used to indicate whether the data block changes relative to a previous backup, and a change identifier value corresponding to the data block varies each time after the data block changes.

In one embodiment, the determining a changed data block in the t^{th} backup relative to the m^{th} backup includes:

determining, through comparison, whether a change identifier value corresponding to a data block in a backup mapping table of the t^{th} backup is the same as a change identifier value corresponding to a data block at a same storage location in a backup mapping table of the m^{th} backup; and

determining a data block with a different change identifier value as the changed data block in the t^{th} backup relative to the m^{th} backup.

In one embodiment, the changed data block in the t^{th} backup relative to the m^{th} backup is determined by determining, through comparison, whether the change identifier value corresponding to the data block in the backup mapping table of the t^{th} backup is the same as the change identifier value corresponding to the data block at the same storage location in the backup mapping table of the m^{th} backup. Therefore, efficiency of determining a changed data block can be improved.

According to a second aspect, an embodiment of this application provides an incremental data restoration apparatus, including:

a creation module, configured to create a current snapshot of data;

a determining module, configured to determine a changed data block in the current snapshot relative to an m^{th} backup, where m is a positive integer, and the m^{th} backup is not a last backup; and

a restoration module, configured to restore data corresponding to the changed data block to data corresponding to a corresponding data block in the m^{th} backup.

In one embodiment, the determining module is configured to:

determine whether there is a changed data block between the current snapshot and a snapshot of a t^{th} backup, where t is a positive integer, and m is less than t; and

determine a changed data block in the t^{th} backup relative to the m^{th} backup if there is no changed data block between the current snapshot and the snapshot of the t^{th} backup.

In one embodiment, the restoration module is configured to:

restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the restoration module is configured to:

restore data corresponding to a changed data block in the current snapshot relative to the snapshot of the t^{th} backup to data corresponding to a corresponding data block in the t^{th} backup;

determine a changed data block in the t^{th} backup relative to the m^{th} backup; and

restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the restoration module is configured to:

record a first storage location of a changed data block in the current snapshot relative to the snapshot of the t^{th} backup;

determine a changed data block in the t^{th} backup relative to the m^{th} backup, and record a second storage location of the changed data block in the t^{th} backup relative to the m^{th} backup;

restore data in the data block corresponding to the recorded first storage location to data corresponding to a corresponding data block in the t^{th} backup; and

restore data in the data block corresponding to the recorded second storage location to data corresponding to a corresponding data block in the m^{th} backup.

In one embodiment, the creation module is further configured to create a backup mapping table, where the backup mapping table includes a storage location of the data block and a change identifier of the data block, the change identifier is used to indicate whether the data block changes relative to a previous backup, and a change identifier value corresponding to the data block varies each time after the data block changes.

In one embodiment, the determining module is configured to:

determine, through comparison, whether a change identifier value corresponding to a data block in a backup mapping table of the t^{th} backup is the same as a change identifier value corresponding to a data block at a same storage location in a backup mapping table of the m^{th} backup; and

determine a data block with a different change identifier value as the changed data block in the t^{th} backup relative to the m^{th} backup.

For beneficial effects of the incremental data restoration apparatus provided in the second aspect and the embodiments of the second aspect, refer to the beneficial effects brought by the first aspect and the embodiments of the first aspect. Details are not described herein again.

According to a third aspect, an embodiment of this application provides a terminal device, including:

a processor configured to create a current snapshot of data.

The processor is further configured to determine a changed data block in the current snapshot relative to an m^{th} backup, where m is a positive integer, and the m^{th} backup is not a last backup.

The processor is further configured to restore data corresponding to the changed data block to data corresponding to a corresponding data block in the m^{th} backup.

In one embodiment, the processor is further configured to determine whether there is a changed data block between the current snapshot and a snapshot of a t^{th} backup, where t is a positive integer, and m is less than t.

The processor is further configured to determine a changed data block in the t^{th} backup relative to the m^{th} backup if there is no changed data block between the current snapshot and the snapshot of the t^{th} backup.

In one embodiment, the processor is further configured to restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the processor is further configured to restore data corresponding to a changed data block in the current snapshot relative to the snapshot of the t^{th} backup to data corresponding to a corresponding data block in the t^{th} backup.

The processor is further configured to determine a changed data block in the t^{th} backup relative to the m^{th} backup.

The processor is further configured to restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the processor is further configured to record a first storage location of a changed data block in the current snapshot relative to the snapshot of the t^{th} backup.

The processor is further configured to: determine a changed data block in the t^{th} backup relative to the m^{th} backup, and record a second storage location of the changed data block in the t^{th} backup relative to the m^{th} backup.

The processor is further configured to restore data in the data block corresponding to the recorded first storage location to data corresponding to a corresponding data block in the t^{th} backup.

The processor is further configured to restore data in the data block corresponding to the recorded second storage location to data corresponding to a corresponding data block in the m^{th} backup.

In one embodiment, the processor is further configured to create a backup mapping table, where the backup mapping table includes a storage location of the data block and a change identifier of the data block, the change identifier is used to indicate whether the data block changes relative to a previous backup, and a change identifier value corresponding to the data block varies each time after the data block changes.

In one embodiment, the processor is further configured to determine, through comparison, whether a change identifier value corresponding to a data block in a backup mapping table of the t^{th} backup is the same as a change identifier value corresponding to a data block at a same storage location in a backup mapping table of the m^{th} backup.

The processor is further configured to determine a data block with a different change identifier value as the changed data block in the t^{th} backup relative to the m^{th} backup.

For beneficial effects of the terminal device provided in the third aspect and the embodiments of the third aspect, refer to the beneficial effects brought by the first aspect and the embodiments of the first aspect. Details are not described herein again.

### BRIEF DESCRIPTION OF DRAWINGS

To describe the technical solutions in the embodiments of the present invention more clearly, the following briefly introduces the accompanying drawings required for describing the embodiments.

FIG. 1 is a schematic diagram of a data backup;

FIG. 2 is a schematic diagram of an incremental backup;

FIG. 3 is a schematic flowchart of an incremental data restoration method according to an embodiment of this application;

FIG. 4 is a schematic diagram of incremental restoration;

FIG. 5 is a schematic flowchart of determining a changed data block;

FIG. 6a is a schematic diagram of a backup mapping table in a full backup;

FIG. 6b is a schematic diagram of a backup mapping table in an incremental backup 1;

FIG. 7a is a schematic diagram of a backup mapping table in an m^{th} backup;

FIG. 7b is a schematic diagram of a backup mapping table in a t^{th} backup;

FIG. 8 is a schematic flowchart of an incremental data restoration method according to another embodiment;

FIG. 9 is a schematic structural diagram of an incremental data restoration apparatus according to an embodiment of the present invention; and

FIG. 10 is a schematic structural diagram of a terminal device according to an embodiment of the present invention.

### DESCRIPTION OF EMBODIMENTS

The technical solutions according to embodiments of the present invention are clearly described in the following with reference to the accompanying drawings.

An incremental data restoration method in the embodiments of this application is applicable to an incremental data backup scenario. A data difference between two backups may be quickly determined through comparison only by determining, through comparison, a difference between snapshots corresponding to the two backups. However, excessive snapshots not only occupy system storage space, but also affect system performance. Therefore, only a snapshot of a latest backup is reserved in most backup systems. However, if a backup restoration point selected by a user is not the last backup, incremental restoration fails, and only full restoration can be used.

Therefore, the incremental data restoration method and apparatus provided in the embodiments of this application are intended to resolve a prior-art technical problem of how to restore data through incremental restoration when a backup restoration point is not a last backup, that is, when there is no snapshot of the backup restoration point.

An incremental backup is first described in detail before embodiments of this application are described.

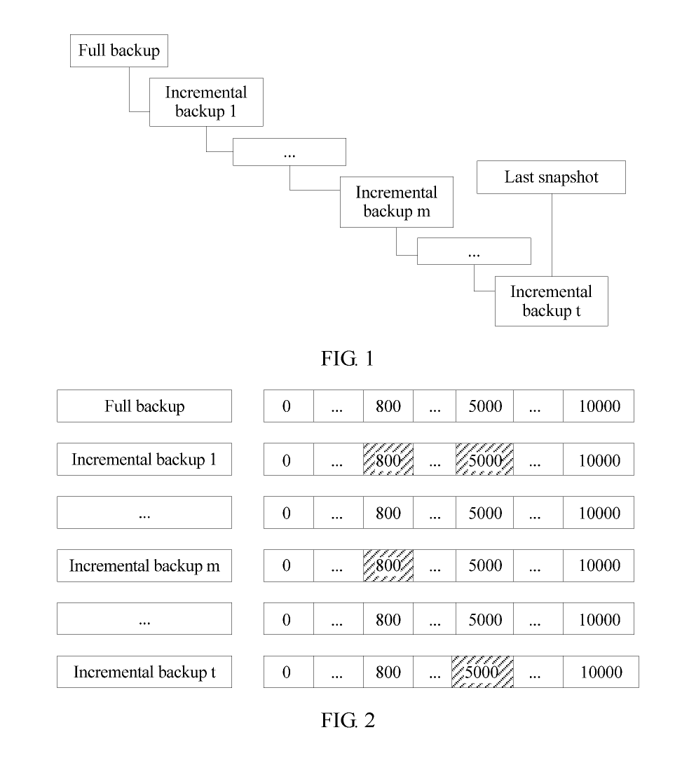

FIG. 1 is a schematic diagram of a data backup. As shown in FIG. 1, when a data backup is performed, there is usually one full backup, and all other t backups are incremental backups. Only a last snapshot, namely, a snapshot corresponding to an incremental backup t, is reserved. FIG. 2 is a schematic diagram of an incremental backup. As shown in FIG. 2, it is assumed that 10000 blocks of data in total need to be backed up. A shaded block in FIG. 2 means that data in the block is different from previous snapshot data. When an incremental backup is performed, only a difference between snapshots needs to be known, a modified part is backed up, and another data block existing before may be still used. For example, only a data block 800 and a data block 5000 are modified in a snapshot of an incremental backup 1 relative to a snapshot of a full backup. Therefore, only the data block 800 and the data block 5000 need to be backed up, and other parts may not be backed up. A manner of another incremental backup is similar to that of the incremental backup 1. Details are not described herein again.

Embodiments are used below to describe in detail the technical solutions of this application. The following several embodiments may be combined with each other, and a same or similar concept or process may not be described repeatedly in some embodiments.

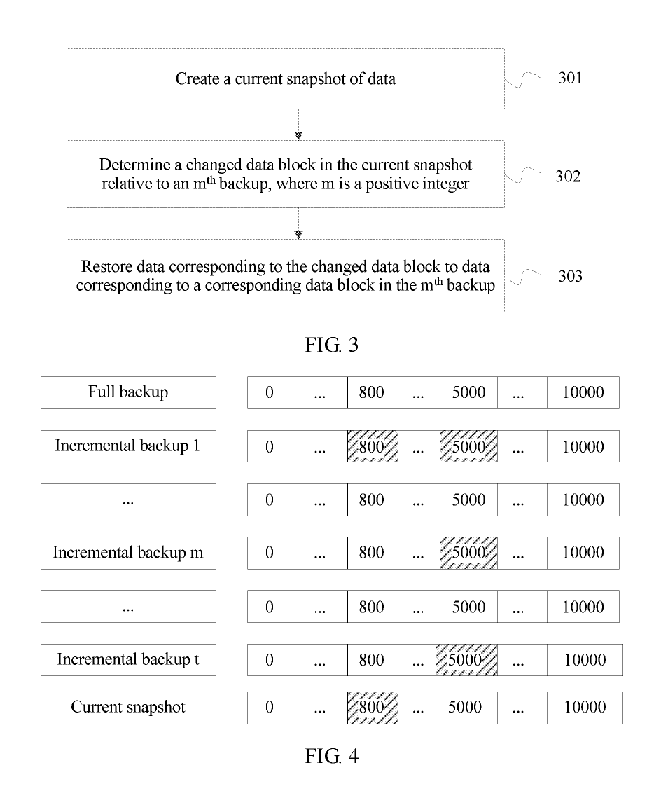

FIG. 3 is a schematic flowchart of an incremental data restoration method according to an embodiment of this application. This embodiment of this application provides an incremental data restoration method. The method may be performed by any apparatus that performs the incremental data restoration method, and the apparatus may be implemented by using software and/or hardware. In this embodiment, the apparatus may be integrated into a terminal device. As shown in FIG. 3, the method in this embodiment may include the following operations.

Operation 301: Create a current snapshot of data.

In this embodiment, when the data is damaged or a user expects to restore the data to data at a previous moment, the terminal device needs to create a current snapshot of current data, to determine a difference between the current snapshot and an m^{th} backup. The m^{th} backup is a backup restoration point to which the user expects to restore the data.

Operation 302: Determine a changed data block in the current snapshot relative to an m^{th} backup, where m is a positive integer.

In this embodiment, after creating the current snapshot, the terminal device may determine the changed data block in the current snapshot relative to the m^{th} backup. The m^{th} backup is a backup restoration point, and is not a last backup, in other words, is an intermediate backup.

Operation 303: Restore data corresponding to the changed data block to data corresponding to a corresponding data block in the m^{th} backup.

In this embodiment, after determining the changed data block, the terminal device may restore the data corresponding to the changed data block in the current snapshot to the data corresponding to the corresponding data block in the m^{th} backup.

In one embodiment, FIG. 4 is a schematic diagram of incremental restoration. If the backup restoration point is a last backup, the terminal device compares the current snapshot with a snapshot of a last backup t, and determines that only a data block 800 changes. Therefore, when data restoration is performed, only data corresponding to a data block 800 in the current snapshot needs to be restored to data corresponding to a data block 800 in an incremental backup m, so that incremental restoration can be completed.

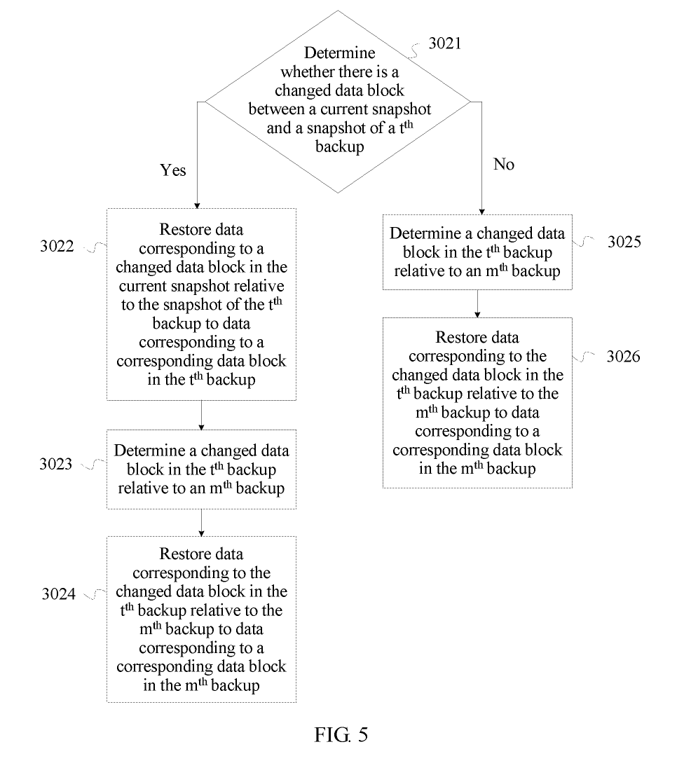

In one embodiment, FIG. 5 is a schematic flowchart of determining a changed data block. As shown in FIG. 5, if the backup restoration point is not a last backup, Operation 303 may further include the following operations.

Operation 3021: Determine whether there is a changed data block between the current snapshot and a snapshot of a t^{th} backup.

The parameter t is a positive integer, and m is less than t. In this embodiment, still referring to FIG. 4, because there is a snapshot of the t^{th} backup, a data block that changes may be learned by comparing the current snapshot with the snapshot of the t^{th} backup. As shown in FIG. 4, the data block 800 in the current snapshot changes relative to the t^{th} backup.

It should be noted that the snapshot of the t^{th} backup is a snapshot of a last backup. In addition, there is a snapshot of only the t^{th} backup, and there are no snapshots of other (t−1) backups. A system stores only the current snapshot and the snapshot of the t^{th} backup, and does not need to store snapshots of all backups. Therefore, storage space can be saved, and system performance can be improved.

Operation 3023 and Operation 3024 are performed after Operation 3022 if there is a changed data block between the current snapshot and the snapshot of the t^{th} backup; or Operation 3025 and Operation 3026 are performed if there is no changed data block between the current snapshot and the snapshot of the t^{th} backup.

Operation 3022: Restore data corresponding to a changed data block in the current snapshot relative to the snapshot of the t^{th} backup to data corresponding to a corresponding data block in the t^{th} backup.

In this embodiment, if there is a changed data block between the current snapshot and the snapshot of the t^{th} backup, the data corresponding to the determined changed data block is restored to the data corresponding to the corresponding data block in the t^{th} backup. Still referring to FIG. 4, the data block 800 in the current snapshot changes relative to the snapshot of the t^{th} backup. Therefore, the data corresponding to the data block 800 in the current snapshot may be restored to the data corresponding to the data block 800 in the t^{th} backup.

Operation 3023: Determine a changed data block in the t^{th} backup relative to the m^{th} backup.

In this embodiment, if there is a changed data block between the current snapshot and the snapshot of the t^{th} backup, the terminal device determines the changed data block in the t^{th} backup relative to the m^{th} backup after restoring the data corresponding to the changed data block in the current snapshot to the data corresponding to the corresponding data block in the t^{th} backup.

In one embodiment, before determining the changed data block in the t^{th} backup relative to the m^{th} backup, the terminal device may further create a backup mapping table. The backup mapping table includes a storage location of a data block and a change identifier of the data block, the change identifier is used to indicate whether the data block changes relative to a previous backup, and a change identifier value corresponding to the data block varies each time after the data block changes.

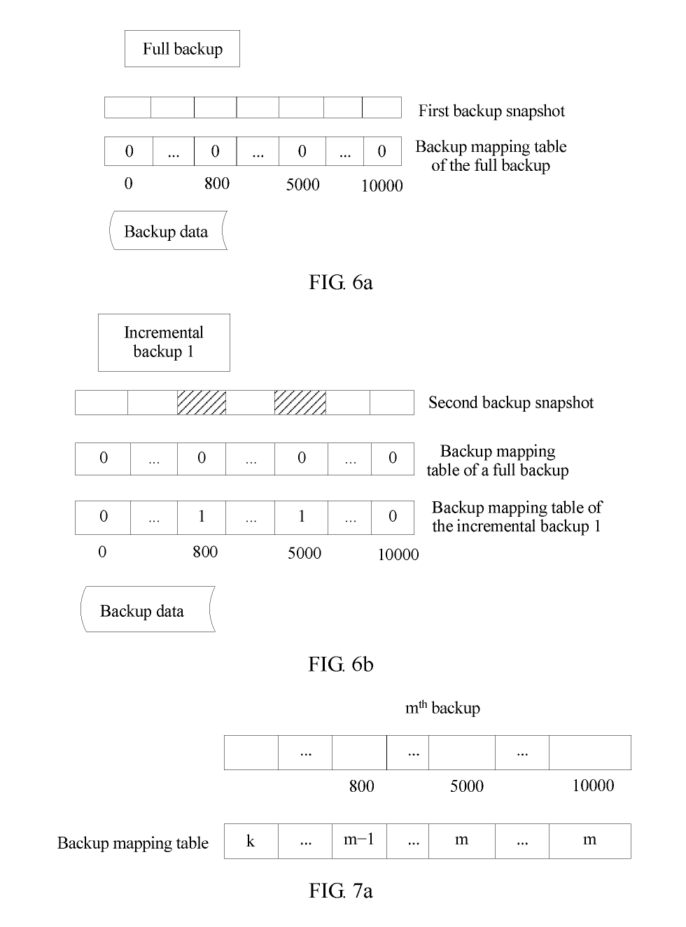

In one embodiment, a specific data storage location of each backup data block needs to be learned in both an incremental backup and a full backup. In one embodiment, an array may be stored in the backup mapping table, a sequence number of each array is a block number of a data block, an array value is a change identifier, the change identifier and the block number can be used to obtain a unique file name, and a specific data block is stored. For example, FIG. 6a is a schematic diagram of a backup mapping table in a full backup, and FIG. 6b is a schematic diagram of a backup mapping table in an incremental backup 1. As shown in FIG. 6a and FIG. 6b, the terminal device may create a backup mapping table in the full backup, and the backup mapping table stores a storage location of a data block and a change identifier corresponding to the data block. For example, a change identifier of a data block 0 is 0, . . . , a change identifier of a data block 800 is 0, . . . , and a change identifier of a data block 10000 is 0. Data corresponding to a data block 800 and data corresponding to a data block 5000 change in the incremental backup 1. Therefore, the terminal device creates a backup mapping table corresponding to the incremental backup 1, to be specific, updates change identifier values corresponding to the data block 800 and the data block 5000 in the backup mapping table to 1. It should be noted that, a change identifier value corresponding to each data block in the full backup is still stored, and is not deleted, to facilitate subsequent comparison. Similarly, in an incremental backup 2, if a data block changes, a change identifier value corresponding to the changed data block may change. It should be noted that a change identifier value obtained after each change is different from a historical value. For example, a change identifier value corresponding to the data block 800 is 0 in the full backup, the data block 800 changes in the incremental backup 1, and the change identifier value corresponding to the data block 800 changes to 1. The data block 800 changes again in the incremental backup 2, and the change identifier value corresponding to the data block 800 changes to 2 or the like. In other words, the change identifier value corresponding to the data block 800 cannot be 0 and 1 again.

After creating the backup mapping table, the terminal device determines the changed data block in the t^{th} backup relative to the m^{th} backup based on the change identifier in the backup mapping table. In actual application, the terminal device determines, through comparison, whether a change identifier value corresponding to a data block in a backup mapping table of the t^{th} backup is the same as a change identifier value corresponding to a data block at a same storage location in a backup mapping table of the m^{th} backup, and determines that a data block with a different change identifier value as the changed data block in the t^{th} backup relative to the m^{th} backup.

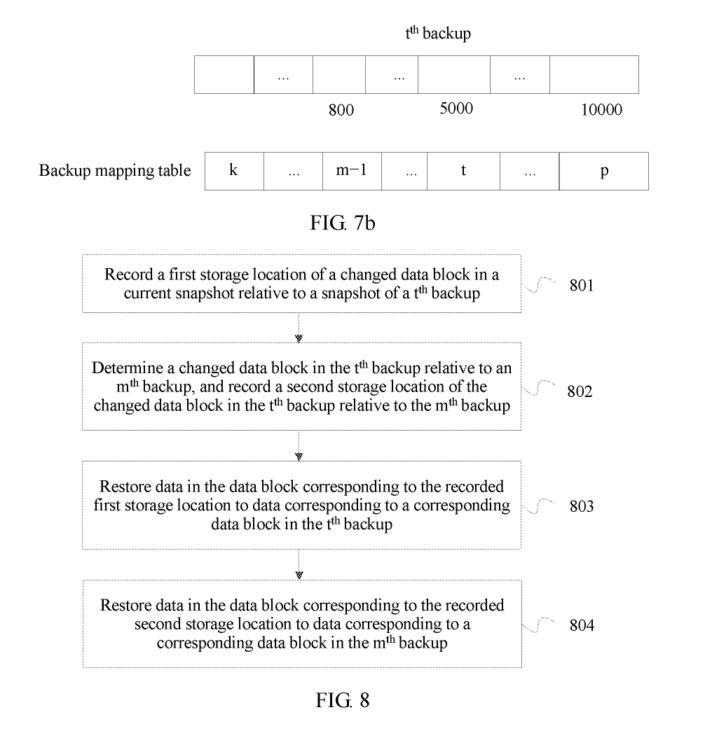

In one embodiment, because the backup mapping table stores the change identifier corresponding to the data block, the terminal device may determine the changed data block in the t^{th} backup relative to the m^{th} backup by comparing a change identifier value corresponding to a data block in the t^{th} backup with a change identifier value corresponding to a data block in the m^{th} backup. For example, FIG. 7a is a schematic diagram of a backup mapping table in an m^{th} backup, and FIG. 7b is a schematic diagram of a backup mapping table in a t^{th} backup. As shown in FIG. 7a and FIG. 7b, in the m^{th} backup, a change identifier value of a data block 800 is m−1, a change identifier value of a data block 5000 is m, and a change identifier value of a data block 10000 is m; in the t^{th} backup, a change identifier value of a data block 800 is m−1, a change identifier value of a data block 5000 is t, and a change identifier value of a data block 10000 is p. Because both the change identifier of the data block 800 in the m^{th} backup and the change identifier of the data block 800 in the t^{th} backup are m−1, the data block 800 does not change. However, the change identifier value of the data block 5000 and the change identifier value of the data block 10000 in the t^{th} backup change relative to the m^{th} backup. Therefore, the data block 500 and the data block 10000 are changed data blocks in the t^{th} backup relative to the m^{th} backup.

Operation 3024: Restore data corresponding to the changed data block in the t^{th} backup relative to the m^{th} backup to data corresponding to a corresponding data block in the m^{th} backup.

In this embodiment, after determining the changed data block in the t^{th} backup relative to the m^{th} backup, the terminal device may restore the data corresponding to the changed data block to the data corresponding to the corresponding data block in the m^{th} backup. Still referring to FIG. 7a and FIG. 7b, because the data block 5000 and the data block 10000 change, data corresponding to the data block 5000 and data corresponding to the data block 10000 are restored to data corresponding to the data block 5000 and data corresponding to the data block 10000 in the m^{th} backup when data restoration is performed.

Operation 3025: Determine a changed data block in the t^{th} backup relative to the m^{th} backup.

In this embodiment, the changed data block in the t^{th} backup relative to the m^{th} backup may be directly determined if there is no changed data block between the current snapshot and the snapshot of the t^{th} backup. A specific manner of determining the changed data block in the t^{th} backup relative to the m^{th} backup is similar to the determining manner in Operation 3023. Details are not described herein again.

Operation 3026: Restore data corresponding to the changed data block in the t^{th} backup relative to the m^{th} backup to data corresponding to a corresponding data block in the m^{th} backup.

In this embodiment, after the changed data block in the t^{th} backup relative to the m^{th} backup is determined, the data corresponding to the changed data block may be directly restored to the data corresponding to the corresponding data block in the m^{th} backup.

According to the incremental data restoration method provided in this embodiment of this application, the current snapshot of the data is created, the changed data block in the current snapshot relative to the m^{th} backup is determined, and the data corresponding to the changed data block is restored to the data corresponding to the corresponding data block in the m^{th} backup. When the m^{th} backup is not a last backup, in other words, there is no snapshot of the m^{th} backup, the changed data block in the current snapshot relative to the m^{th} backup is determined, and the data corresponding to the changed data block is restored to the data corresponding to the corresponding data block in the m^{th} backup, so that incremental restoration is effective, and incremental restoration reliability can be improved.

In one embodiment, FIG. 8 is a schematic flowchart of Embodiment 2 of an incremental data restoration method. As shown in FIG. 8, if there is a changed data block between a current snapshot and a snapshot of a t^{th} backup, Operation 303 may further include the following operations.

Operation 801: Record a first storage location of a changed data block in a current snapshot relative to a snapshot of a t^{th} backup.

In this embodiment, the first storage location of the changed data block in the current snapshot relative to the snapshot of the t^{th} backup may be first recorded if there is a changed data block between the current snapshot and the snapshot of the t^{th} backup. For example, a storage location of a data block 800 in the current snapshot may be recorded if the data block 800 changes relative to the snapshot of the t^{th} backup.

Operation 802: Determine a changed data block in the t^{th} backup relative to an m^{th} backup, and record a second storage location of the changed data block in the t^{th} backup relative to the m^{th} backup.

In this embodiment, after determining the first storage location of the changed data block in the current snapshot relative to the snapshot of the t^{th} backup, a terminal device determines the changed data block in the t^{th} backup relative to the m^{th} backup. A specific determining manner is similar to that in Operation 3023. Details are not described herein again. The second storage location of the changed data block is recorded after the changed data block in the t^{th} backup relative to the m^{th} backup is determined. For example, a storage location of a data block 10000 in the t^{th} backup may be recorded if the data block 10000 changes relative to the m^{th} backup.

Operation 803: Restore data in the data block corresponding to the recorded first storage location to data corresponding to a corresponding data block in the t^{th} backup.

In this embodiment, the terminal device does not restore a changed data block after determining the changed data block. Instead, the terminal device records a storage location of the changed data block, and restores all changed data blocks together after determining all the changed data blocks. After recording the first storage location, the terminal device restores the data in the data block corresponding to the recorded first storage location to the data corresponding to the corresponding data block in the t^{th} backup.

Operation 804: Restore data in the data block corresponding to the recorded second storage location to data corresponding to a corresponding data block in the m^{th} backup.

In this embodiment, after restoring the data in the data block corresponding to the first storage location, the terminal device restores the data in the data block corresponding to the second storage location to the data corresponding to the corresponding data block in the m^{th} backup.

According to the incremental data restoration method provided embodiments of this application, if there is a changed data block between the current snapshot and the snapshot of the t^{th} backup, the first storage location of the changed data block in the current snapshot relative to the snapshot of the t^{th} backup may be recorded, the changed data block in the t^{th} backup relative to the m^{th} backup is determined, and the second storage location of the changed data block in the t^{th} backup relative to the m^{th} backup is recorded. The data in the data block corresponding to the recorded first storage location is restored to the data corresponding to the corresponding data block in the t^{th} backup, and the data in the data block corresponding to the recorded second storage location is restored to the data corresponding to the corresponding data block in the m^{th} backup. Data restoration efficiency can be improved because all changed data blocks are restored together after all the changed data blocks are determined.

Persons of ordinary skill in the art may understand that all or some of the operations of the method embodiments may be implemented by a program instructing relevant hardware. The program may be stored in a computer-readable storage medium. When the program runs, the operations of the method embodiments are performed. The foregoing storage medium includes: any medium that can store program code, such as a ROM, a RAM, a magnetic disk, or an optical disc.

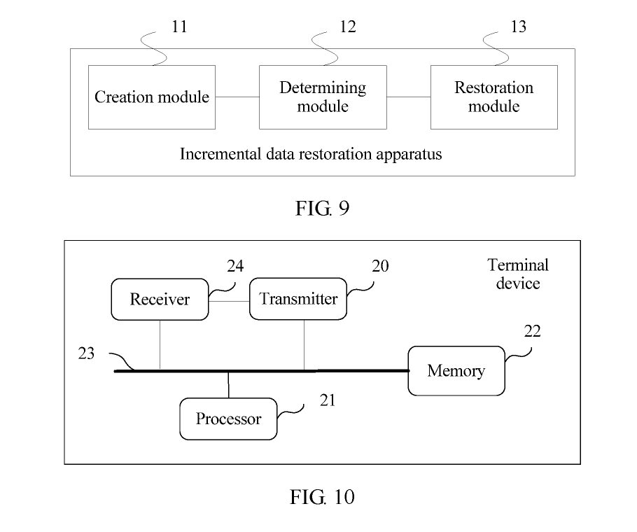

FIG. 9 is a schematic structural diagram of an incremental data restoration apparatus according to an embodiment of the present invention. The restoration apparatus may be an independent terminal device, or may be an apparatus integrated into a terminal device. The apparatus may be implemented by using software, hardware, or a combination of software and hardware. As shown in FIG. 9, the restoration apparatus includes:

a creation module 11, configured to create a current snapshot of data;

a determining module 12, configured to determine a changed data block in the current snapshot relative to an m^{th} backup, where m is a positive integer, and the m^{th} backup is not a last backup; and

a restoration module 13, configured to restore data corresponding to the changed data block to data corresponding to a corresponding data block in the m^{th} backup.

In one embodiment, the creation module 11, the determining module 12, and the restoration module 13 may be correspondingly a processor in the terminal device.

The incremental data restoration apparatus provided in this embodiment of the present invention can perform the foregoing method embodiment. An implementation principle and a technical effect thereof are similar to those of the method embodiment, and are not described herein again.

In one embodiment, the determining module 12 is further configured to:

determine whether there is a changed data block between the current snapshot and a snapshot of a t^{th} backup, where t is a positive integer, and m is less than t; and

determine a changed data block in the t^{th} backup relative to the m^{th} backup if there is no changed data block between the current snapshot and the snapshot of the t^{th} backup.

In one embodiment, the restoration module 13 is further configured to:

restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the restoration module 13 is further configured to:

restore data corresponding to a changed data block in the current snapshot relative to the snapshot of the t^{th} backup to data corresponding to a corresponding data block in the t^{th} backup;

determine a changed data block in the t^{th} backup relative to the m^{th} backup; and

restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the restoration module 13 is further configured to:

record a first storage location of a changed data block in the current snapshot relative to the snapshot of the t^{th} backup;

determine a changed data block in the t^{th} backup relative to the m^{th} backup, and record a second storage location of the changed data block in the t^{th} backup relative to the m^{th} backup;

restore data in the data block corresponding to the recorded first storage location to data corresponding to a corresponding data block in the t^{th} backup; and

restore data in the data block corresponding to the recorded second storage location to data corresponding to a corresponding data block in the m^{th} backup.

In one embodiment, the creation module 11 is further configured to create a backup mapping table. The backup mapping table includes a storage location of the data block and a change identifier of the data block, the change identifier is used to indicate whether the data block changes relative to a previous backup, and a change identifier value corresponding to the data block varies each time after the data block changes.

In one embodiment, the determining module 12 is further configured to:

determine, through comparison, whether a change identifier value corresponding to a data block in a backup mapping table of the t^{th} backup is the same as a change identifier value corresponding to a data block at a same storage location in a backup mapping table of the m^{th} backup; and

determine a data block with a different change identifier value as the changed data block in the t^{th} backup relative to the m^{th} backup.

The incremental data restoration apparatus provided in this embodiment of the present invention can perform the foregoing method embodiment. An implementation principle and a technical effect thereof are similar to those of the method embodiment, and are not described herein again.

FIG. 10 is a schematic structural diagram of an embodiment of a terminal device according to an embodiment of the present invention. As shown in FIG. 10, the terminal device may include a transmitter 20, a processor 21, a memory 22, and at least one communications bus 23. The communications bus 23 is configured to implement a communication connection between components. The memory 22 may include a high-speed RAM memory, or may include a nonvolatile memory NVM, for example, at least one magnetic disk storage. The memory 22 may store various programs, to complete various processing functions and implement operations of the method in the embodiments. In addition, the terminal device may further include a receiver 24. The receiver 24 in this embodiment may be a corresponding input interface that has a communication function and an information receiving function. The transmitter 20 in this embodiment may be a corresponding output interface that has a communication function and an information sending function. In one embodiment, the transmitter 20 and the receiver 24 may be integrated into one communications interface, or may be two independent communications interfaces.

In this embodiment, the processor 21 is configured to create a current snapshot of data.

The processor 21 is further configured to determine a changed data block in the current snapshot relative to an m^{th} backup, where m is a positive integer, and the m^{th} backup is not a last backup.

The processor 21 is further configured to restore data corresponding to the changed data block to data corresponding to a corresponding data block in the m^{th} backup.

In one embodiment, the processor 21 is further configured to determine whether there is a changed data block between the current snapshot and a snapshot of a t^{th} backup, where t is a positive integer, and m is less than t.

The processor 21 is further configured to determine a changed data block in the t^{th} backup relative to the m^{th} backup if there is no changed data block between the current snapshot and the snapshot of the t^{th} backup.

In one embodiment, the processor 21 is further configured to restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the processor 21 is further configured to restore data corresponding to a changed data block in the current snapshot relative to the snapshot of the t^{th} backup to data corresponding to a corresponding data block in the t^{th} backup.

The processor 21 is further configured to determine a changed data block in the t^{th} backup relative to the m^{th} backup.

The processor 21 is further configured to restore data corresponding to the changed data block in the t^{th} backup relative to the m^{th} backup to data corresponding to a corresponding data block in the m^{th} backup.

In one embodiment, if there is a changed data block between the current snapshot and the snapshot of the t^{th} backup, the processor 21 is further configured to record a first storage location of a changed data block in the current snapshot relative to the snapshot of the t^{th} backup.

The processor 21 is further configured to: determine a changed data block in the t^{th} backup relative to the m^{th} backup, and record a second storage location of the changed data block in the t^{th} backup relative to the m^{th} backup.

The processor 21 is further configured to restore data in the data block corresponding to the recorded first storage location to data corresponding to a corresponding data block in the t^{th} backup.

The processor 21 is further configured to restore data in the data block corresponding to the recorded second storage location to data corresponding to a corresponding data block in the m^{th} backup.

In one embodiment, the processor 21 is further configured to create a backup mapping table. The backup mapping table includes a storage location of the data block and a change identifier of the data block, the change identifier is used to indicate whether the data block changes relative to a previous backup, and a change identifier value corresponding to the data block varies each time after the data block changes.

In one embodiment, the processor 21 is further configured to determine, through comparison, whether a change identifier value corresponding to a data block in a backup mapping table of the t^{th} backup is the same as a change identifier value corresponding to a data block at a same storage location in a backup mapping table of the m^{th} backup.

The processor 21 is further configured to determine a data block with a different change identifier value as the changed data block in the t^{th} backup relative to the m^{th} backup.

The terminal device provided in this embodiment of the present invention can perform the foregoing method embodiment. An implementation principle and a technical effect thereof are similar to those of the method embodiment, and are not described herein again.

Finally, it should be noted that functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention, or the part contributing to the art, or all or some of the technical solutions may be implemented in the form of a software product. The software product is stored in a storage medium and includes several instructions for instructing a computer device (which may be a personal computer, a server, or a network device) to perform all or some of the operations of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended to describe the technical solutions of this application, but not to limit this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

What is claimed is:

1. A method of incremental data restoration, comprising:
creating a current snapshot of data;
determining a changed data block in the current snapshot relative to an m^{th} backup, wherein m is a positive integer, and the m^{th} backup is not a last backup; and
restoring data corresponding to the changed data block to data corresponding to a corresponding data block in the m^{th} backup.

2. The method according to claim 1, wherein the determining a changed data block in the current snapshot relative to an m^{th} backup comprises:
determining whether there is a changed data block between the current snapshot and a snapshot of a t^{th} backup, wherein t is a positive integer, and m is less than t; and
determining a changed data block in the t^{th} backup relative to the m^{th} backup if there is no changed data block between the current snapshot and the snapshot of the t^{th} backup.

3. The method according to claim 2, wherein the restoring data corresponding to the changed data block to data corresponding to a corresponding data block in the m^{th} backup comprises:
restoring data corresponding to the changed data block in the t^{th} backup relative to the m^{th} backup to data corresponding to a corresponding data block in the m^{th} backup.

4. The method according to claim 2, further comprising:
if there is a changed data block between the current snapshot and the snapshot of the t^{th} backup, the restoring data corresponding to the changed data block to data corresponding to a corresponding data block in the m^{th} backup comprises:
restoring data corresponding to a changed data block in the current snapshot relative to the snapshot of the t^{th} backup to data corresponding to a corresponding data block in the t^{th} backup;
determining a changed data block in the t^{th} backup relative to the m^{th} backup; and
restoring data corresponding to the changed data block in the t^{th} backup relative to the m^{th} backup to data corresponding to a corresponding data block in the m^{th} backup.

5. The method according to claim 2, further comprising:
if there is a changed data block between the current snapshot and the snapshot of the t^{th} backup, the restoring data corresponding to the changed data block to data corresponding to a corresponding data block in the m^{th} backup comprises:
recording a first storage location of a changed data block in the current snapshot relative to the snapshot of the t^{th} backup;
determining a changed data block in the t^{th} backup relative to the m^{th} backup, and recording a second storage location of the changed data block in the t^{th} backup relative to the m^{th} backup;
restoring data in the data block corresponding to the recorded first storage location to data corresponding to a corresponding data block in the t^{th} backup; and
restoring data in the data block corresponding to the recorded second storage location to data corresponding to a corresponding data block in the m^{th} backup.

6. The method according to claim 2, wherein before the determining a changed data block in the t^{th} backup relative to the m^{th} backup, the method further comprising:
creating a backup mapping table, wherein the backup mapping table comprises a storage location of a data block and a change identifier of the data block, the change identifier is used to indicate whether the data block changes relative to a previous backup, and a change identifier value corresponding to the data block varies each time after the data block changes.

7. The method according to claim 6, wherein the determining a changed data block in the t^{th} backup relative to the m^{th} backup comprises:
determining, through comparison, whether a change identifier value corresponding to a data block in a backup mapping table of the t^{th} backup is the same as a change identifier value corresponding to a data block at a same storage location in a backup mapping table of the m^{th} backup; and
determining a data block with a different change identifier value as the changed data block in the t^{th} backup relative to the m^{th} backup.

8. An apparatus, comprising:
a memory for storing program instructions; and
a processor configured to execute the instructions to:
create a current snapshot of data;
determine a changed data block in the current snapshot relative to an m^{th} backup, wherein m is a positive integer, and the m^{th} backup is not a last backup; and
restore data corresponding to the changed data block to data corresponding to a corresponding data block in the m^{th} backup.

9. The apparatus according to claim 8, wherein the processor is further configured to:
determine whether there is a changed data block between the current snapshot and a snapshot of a t^{th} backup, wherein t is a positive integer, and m is less than t; and
determine a changed data block in the t^{th} backup relative to the m^{th} backup if there is no changed data block between the current snapshot and the snapshot of the t^{th} backup.

10. The apparatus according to claim 9, wherein the processor is further configured to:
restore data corresponding to the changed data block in the t^{th} backup relative to the m^{th} backup to data corresponding to a corresponding data block in the m^{th} backup.

11. The apparatus according to claim 9, wherein the processor is further configured to:
restore data corresponding to a changed data block in the current snapshot relative to the snapshot of the t^{th} backup to data corresponding to a corresponding data block in the t^{th} backup;
determine a changed data block in the t^{th} backup relative to the m^{th} backup; and
restore data corresponding to the changed data block in the t^{th} backup relative to the m^{th} backup to data corresponding to a corresponding data block in the m^{th} backup.

12. The apparatus according to claim 9, wherein the processor is further configured to:
record a first storage location of a changed data block in the current snapshot relative to the snapshot of the t^{th} backup;
determine a changed data block in the t^{th} backup relative to the m^{th} backup, and record a second storage location of the changed data block in the t^{th} backup relative to the m^{th} backup;
restore data in the data block corresponding to the recorded first storage location to data corresponding to a corresponding data block in the t^{th} backup; and
restore data in the data block corresponding to the recorded second storage location to data corresponding to a corresponding data block in the m^{th} backup.

13. The apparatus according to claim 9, wherein the processor is further configured to create a backup mapping table, wherein the backup mapping table comprises a storage location of the data block and a change identifier of the data block, the change identifier is used to indicate whether the data block changes relative to a previous backup, and a change identifier value corresponding to the data block varies each time after the data block changes.

14. The apparatus according to claim 13, wherein the processor is further configured to:
determine, through comparison, whether a change identifier value corresponding to a data block in a backup mapping table of the t^{th} backup is the same as a change identifier value corresponding to a data block at a same storage location in a backup mapping table of the m^{th} backup; and
determine a data block with a different change identifier value as the changed data block in the t^{th} backup relative to the m^{th} backup.

15. A non-transitory computer-readable storage medium having instructions stored therein, which when executed by a processor, cause the processor to perform operations, the operations comprising:
creating a current snapshot of data;
determining a changed data block in the current snapshot relative to an m^{th} backup, wherein m is a positive integer, and the m^{th} backup is not a last backup; and
restoring data corresponding to the changed data block to data corresponding to a corresponding data block in the m^{th} backup.

16. The non-transitory computer-readable storage medium according to claim 15, wherein the determining a changed data block in the current snapshot relative to an m^{th} backup comprises:
determining whether there is a changed data block between the current snapshot and a snapshot of a t^{th} backup, wherein t is a positive integer, and m is less than t; and
determining a changed data block in the t^{th} backup relative to the m^{th} backup if there is no changed data block between the current snapshot and the snapshot of the t^{th} backup.

17. The non-transitory computer-readable storage medium according to claim 16, wherein the restoring data corresponding to the changed data block to data corresponding to a corresponding data block in the m^{th} backup comprises:
restoring data corresponding to the changed data block in the t^{th} backup relative to the m^{th} backup to data corresponding to a corresponding data block in the m^{th} backup.

18. The non-transitory computer-readable storage medium according to claim 16, further comprising:
if there is a changed data block between the current snapshot and the snapshot of the t^{th} backup, the restoring data corresponding to the changed data block to data corresponding to a corresponding data block in the m^{th} backup comprises:
restoring data corresponding to a changed data block in the current snapshot relative to the snapshot of the t^{th} backup to data corresponding to a corresponding data block in the t^{th} backup;
determining a changed data block in the t^{th} backup relative to the m^{th} backup; and
restoring data corresponding to the changed data block in the t^{th} backup relative to the m^{th} backup to data corresponding to a corresponding data block in the m^{th} backup.

19. The non-transitory computer-readable storage medium according to claim 16, further comprising:
if there is a changed data block between the current snapshot and the snapshot of the t^{th} backup, the restoring data corresponding to the changed data block to data corresponding to a corresponding data block in the m^{th} backup comprises:
recording a first storage location of a changed data block in the current snapshot relative to the snapshot of the t^{th} backup;
determining a changed data block in the t^{th} backup relative to the m^{th} backup, and recording a second storage location of the changed data block in the t^{th} backup relative to the m^{th} backup;
restoring data in the data block corresponding to the recorded first storage location to data corresponding to a corresponding data block in the t^{th} backup; and
restoring data in the data block corresponding to the recorded second storage location to data corresponding to a corresponding data block in the m^{th} backup.

20. The non-transitory computer-readable storage medium according to claim 16, wherein before the determining a changed data block in the t^{th} backup relative to the m^{th} backup, the operations further comprising:
creating a backup mapping table, wherein the backup mapping table comprises a storage location of a data block and a change identifier of the data block, the change identifier is used to indicate whether the data block changes relative to a previous backup, and a change identifier value corresponding to the data block varies each time after the data block changes.
